(19) United States
(12) Patent Application Publication
(10) Pub. No.: US 2022/0314509 A1
(43) Pub. Date: Oct. 6, 2022

(54) HOT RUNNER DEVICE

(71) Applicant: HONDA MOTOR CO., LTD., TOKYO (JP)

(72) Inventor: Hiroshi MATSUSHIMA, TOKYO (JP)

(21) Appl. No.: 17/681,812

(22) Filed: Feb. 27, 2022

(30) Foreign Application Priority Data
Mar. 30, 2021 (JP) 2021-057568

(51) Int. Cl. B29C 45/27; B29C 45/07; B29C 45/23; B29C 45/56

(52) U.S. Cl. CPC B29C 45/2708; B29C 45/07; B29C 45/23; B29C 45/561; B29C 2045/5635

(57) ABSTRACT

A hot runner device includes a first block and a second block. A supply nozzle is connected to the first block. A nozzle unit is connected to the second block. The first block and the second block are connected to each other so as to be slidable relative to each other along the longitudinal direction of a hot runner block. First and second positioning pins are inserted into first and second insertion holes of the second block. The first insertion hole is larger than the second insertion hole.

### CROSS-REFERENCE TO RELATED APPLICATIONS

This application is based upon and claims the benefit of priority from Japanese Patent Application No. 2021-057568 filed on Mar. 30, 2021, the contents of which are incorporated herein by reference.

### BACKGROUND OF THE INVENTION

### Field of the Invention

The present invention relates to a hot runner device for molding a molded article by injecting a melted resin material.

### Description of the Related Art

Conventionally, injection molding has been known in which a melted resin material is poured into a mold to obtain a resin molded article. In this injection molding, the melted resin material is poured into a mold through a resin flow path. Therefore, when the resin molded article is taken out from the mold, a runner in which the melted resin in the resin flow path is solidified occurs. Since the runner is not required, it is desirable to eliminate the runner. For example, a hot runner device is known in which a melted resin in a resin flow path is heated by a heater or the like to keep the resin in a flowable state. In this hot runner device, since the runner does not solidify, only the resin molded article can be taken out.

A hot runner device disclosed in JP H01-141017 U includes a hot runner block and a sprue bushing. The hot runner block extends in the longitudinal direction of the hot runner device. The sprue bushing is coupled to a longitudinal end of the hot runner block. The sprue bushing is orthogonal to the longitudinal direction of the hot runner block. A runner extends in the longitudinal direction within the hot runner block. Another runner extends in the up-down direction within the sprue bushing. Two runners communicate with each other.

The hot runner device is provided with a positioning pin and a groove. The positioning pin is fitted to the center bottom of the hot runner block. The groove is located closer to the sprue bushing than the positioning pin. The groove extends in the longitudinal direction of the hot runner block. A pin attached to the upper part of the fixed mold is engaged with the groove.

Melted resin is supplied into the hot runner block, and the heat of the melted resin may cause the hot runner block to expand thermally in the longitudinal direction. At this time, the hot runner block moves in the longitudinal direction relative to the fixed mold through the groove with which the pin is engaged. As a result, occurrence of a bending moment between the hot runner block and the fixed mold caused by thermal expansion of the hot runner block is avoided.

### SUMMARY OF THE INVENTION

In the above-described hot runner device, when the hot runner block is thermally expanded, the hot runner block is deformed in the longitudinal direction, and a melted resin supply port is used as the reference of the deformation. Therefore, when the hot runner block is deformed by thermal expansion, the amount of deformation of the hot runner block in the vicinity of the sprue bushing located on the opposite side to the supply port becomes large. As the amount of deformation in the vicinity of the sprue bushing increases, the upper end of the sprue bushing connected to the hot runner block shifts in the longitudinal direction. Thus, the upper end of the sprue bushing is inclined relative to the lower end of the sprue bushing. As a result, when the melted resin is supplied to the hot runner block, it is not possible to smoothly supply the melted resin to the fixed mold via the sprue bushing.

An object of the present invention is to solve the aforementioned problem.

According to an aspect of the present invention, provided is a hot runner device comprising: a fixed mold including a cavity; a runner block fixed to the fixed mold; a nozzle having a tubular shape and fixed to the fixed mold and the runner block in a manner that a tip of the nozzle faces the cavity; and a stem movable in the nozzle in an axial direction of the nozzle and configured to open and close a gate opened at the tip of the nozzle, the hot runner device filling the cavity with injected melted resin from the gate through the runner block, wherein the runner block includes: a first block connected to a supply port to which the melted resin is supplied, and including, on an inside thereof, a first supply flow path which communicates with the supply port and through which the melted resin flows; a second block connected to the first block and to the nozzle, and including, on an inside thereof, a second supply flow path through which the melted resin flows; a connection portion configured to connect a first end portion of the first block and a second end portion of the second block in a manner that the first end portion and the second end portion are slidable relative to each other along a second direction substantially orthogonal to a first direction that is a direction in which the stem moves, the connection portion being configured to allow the first supply flow path and the second supply flow path to communicate with each other; and a fixing mechanism provided at a position where the fixing mechanism overlaps the connection portion in the second direction, and configured to fix the connection portion, and wherein the second block includes, on a surface facing the fixed mold, a plurality of hole portions each engaged with a positioning member, and among the plurality of hole portions, a first hole portion which is farthest from the nozzle in the second direction is larger than a second hole portion which is closest to the nozzle in the second direction.

According to the present invention, when the first and second blocks of the runner block are thermally expanded and deformed, the first block and the second block slide and move relative to each other along the second direction via the connection portion. As a result, it is possible to suppress deformation of the first and second blocks by appropriately absorbing thermal expansion stress applied to the first and second blocks due to thermal expansion. The positioning pin engaged with the second hole portion close to the nozzle is used as the deformation reference for the second block. As a result, the melted resin can be injected from the nozzle while the deformation of the end portion of the second block to which the nozzle is connected is suppressed and the inclination of the nozzle is suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an external perspective view of a hot runner device according to an embodiment of the present invention;

FIG. 2 is a cross-sectional view taken along the line II-II of FIG. 1;

FIG. 3 is an enlarged cross-sectional view of the vicinity of a hot runner block in the hot runner device of FIG. 2;

FIG. 4 is a cross-sectional view taken along the line IV-IV of FIG. 3; and

FIG. 5 is a cross-sectional view showing a state in which a stem of the hot runner device of FIG. 2 rises and melted resin is supplied into a cavity of an injection mold.

### DESCRIPTION OF THE INVENTION

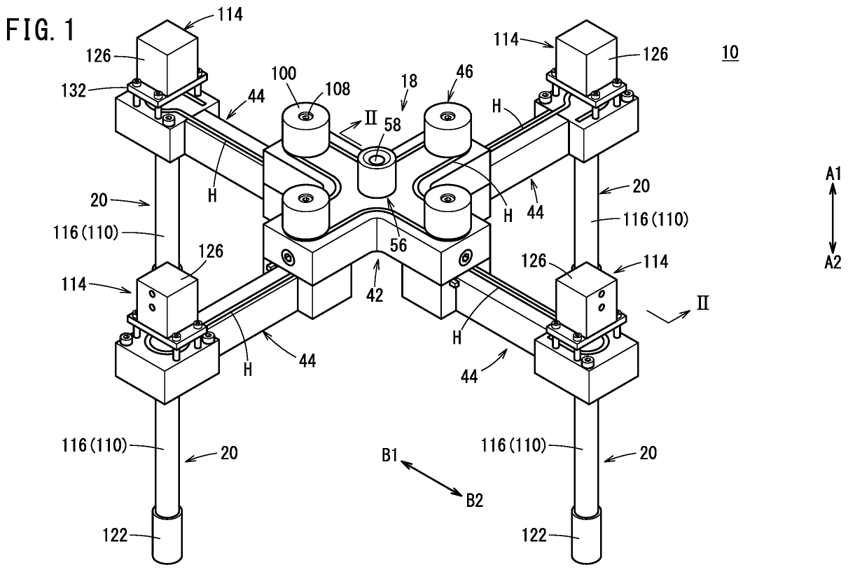

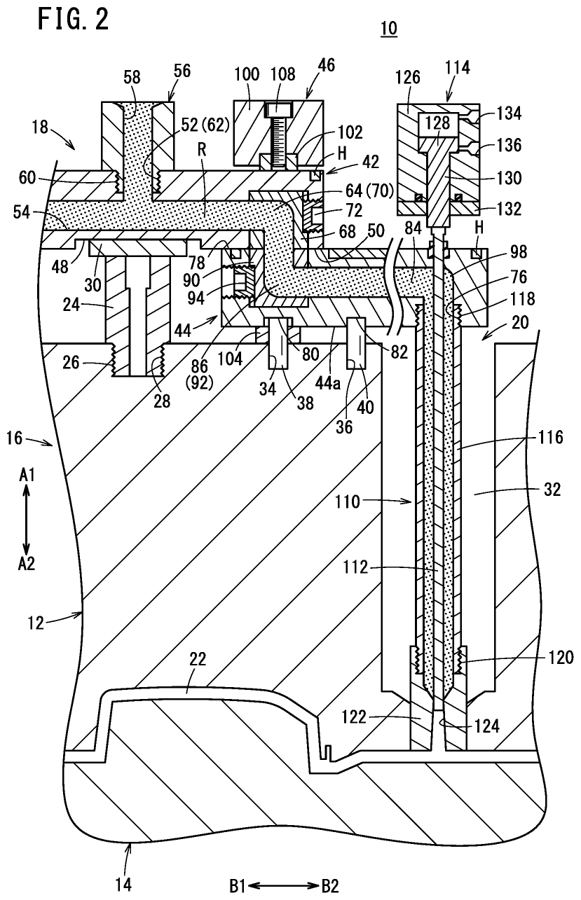

For example, as shown in FIGS. 1 and 2, a hot runner device 10 includes an injection mold 16, a hot runner block (runner block) 18, and a nozzle unit (nozzle) 20. In the following description, for the sake of convenience, the left-right direction in FIG. 2 is referred to as a longitudinal direction (directions of arrows B1 and B2), the left side is referred to as one side in the longitudinal direction (direction of arrow B1), and the right side is referred to as the other side in the longitudinal direction (direction of arrow B2). The longitudinal direction corresponds to a “second direction” in the present invention.

The hot runner block 18 is disposed above a fixed mold 12 (in the direction of arrow A1). The nozzle unit (nozzle) 20 is connected to a longitudinal end portion (another longitudinal end) of the hot runner block 18.

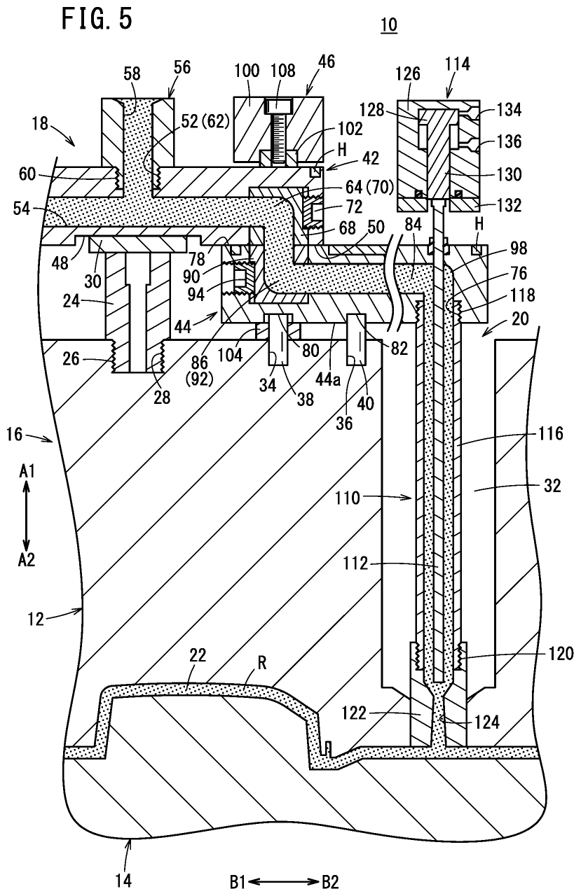

The injection mold 16 includes the fixed mold 12 and a movable mold 14. The movable mold 14 is disposed below the fixed mold 12 (in the direction of arrow A2). The movable mold 14 can be relatively displaced from the fixed mold 12 in the up-down direction (directions of arrows A1 and A2). The movable mold 14 is raised so as to approach the fixed mold 12 during mold closing. A cavity 22 is formed between the upper surface of the movable mold 14 and the lower surface of the fixed mold 12. Melted resin R melted at a high temperature is supplied to the cavity 22 and cooled. As a result, in the injection mold 16, a desired resin molded article having a shape corresponding to the shape of the cavity 22 is molded (see FIG. 5). When the molding of the resin molded article is completed and the mold is opened, the movable mold 14 is lowered and separated from the fixed mold 12. When the fixed mold 12 and the movable mold 14 are separated from each other, the resin molded article can be taken out from the cavity 22.

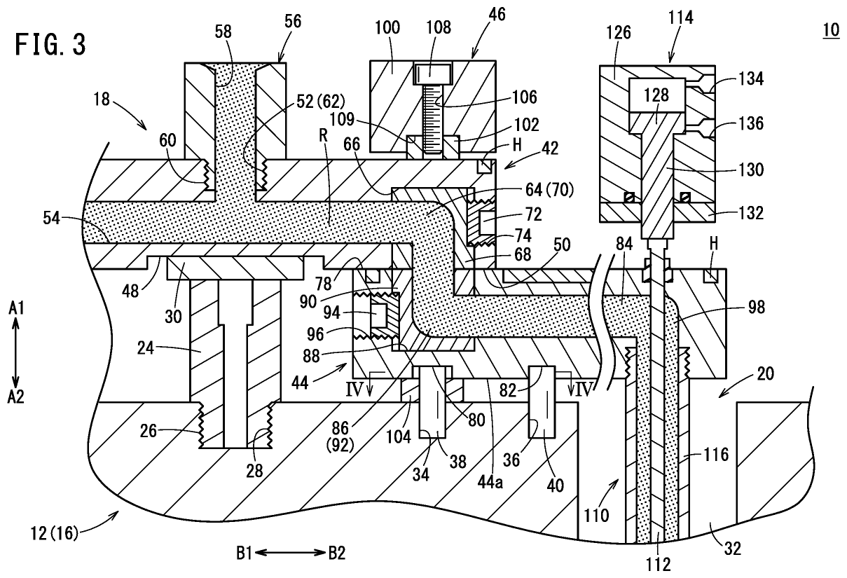

As shown in FIGS. 2 and 3, the fixed mold 12 includes a support base 24. The support base 24 is disposed in the center portion of the upper surface of the fixed mold 12. The support base 24 supports a first block 42 of the hot runner block 18 described later. The support base 24 has a shaft shape having a predetermined length in the up-down direction (directions of arrows A1 and A2). The outer peripheral surface of the lower end of the support base 24 has a first screw portion 26. The first screw portion 26 is inserted into and screwed into a first screw hole 28 opened in the upper surface of the fixed mold 12. When the first screw portion 26 is screwed into the first screw hole 28, the lower end of the support base 24 is fixed to the upper surface of the fixed mold 12. The support base 24 is fixed so as to erect upward (in the direction of arrow A1) from the upper surface of the fixed mold 12. A support plate 30 is attached to the upper end of the support base 24. The support plate 30 has a plate shape extending in the horizontal direction (directions of arrows B1 and B2). The support plate 30 comes into contact with the lower surface of the first block 42 to be described later. The support plate 30 is supported by the first block 42.

The fixed mold 12 has an installation hole 32. The installation hole 32 is separated from the center portion of the fixed mold 12 by a predetermined distance toward the other side in the longitudinal direction. The installation hole 32 extends in the up-down direction (directions of arrows A1 and A2) in the fixed mold 12. The installation hole 32 penetrates from the upper surface of the fixed mold 12 to the lower surface of the fixed mold 12 that faces the cavity 22. The installation hole 32 has a linear shape along the up-down direction. The lower end of the installation hole 32 communicates with the cavity 22. A gate valve 110 of the nozzle unit 20 to be described later is accommodated in the installation hole 32.

The upper surface of the fixed mold 12 includes a set of first and second fitting holes 34 and 36. The set of first and second fitting holes 34 and 36 are disposed between the support base 24 and the installation hole 32. The first and second fitting holes 34 and 36 are recessed downward (in the direction of arrow A2) from the upper surface of the fixed mold 12. The first fitting hole 34 and the second fitting hole 36 have substantially the same shape. The first fitting hole 34 is disposed close to the support base 24 located on one side in the longitudinal direction in the fixed mold 12. The second fitting hole 36 is disposed close to the installation hole 32 located on the other side in the longitudinal direction, which is opposite to the first fitting hole 34, in the fixed mold 12. That is, the first fitting hole 34 and the second fitting hole 36 are separated from each other by a predetermined distance in the longitudinal direction (directions of arrows B1 and B2) in the fixed mold 12.

A first positioning pin (positioning member) 38 is fitted into the first fitting hole 34. A second positioning pin (positioning member) 40 is fitted into the second fitting hole 36. Each of the first and second positioning pins 38 and 40 is a pin having a constant diameter and extending in the axial direction. The lower half of the first positioning pin 38 along the axial direction is fitted into the first fitting hole 34. The lower half of the second positioning pin 40 along the axial direction is fitted into the second fitting hole 36. The upper halves of the first and second positioning pins 38 and 40 along the axial direction protrude upward (in the direction of arrow A1) by a predetermined length from the upper surface of the fixed mold 12. The first and second positioning pins 38 and 40 are fixed to the upper surface of the fixed mold 12.

The hot runner block 18 includes the first block 42, a plurality of second blocks 44, and fixing mechanisms 46. The first block 42 is disposed at a substantially central portion of the hot runner device 10. The second blocks 44 are disposed below the first block 42 (in the direction of arrow A2). The second blocks 44 are offset from the first block 42 toward the other side in the longitudinal direction (in the direction of arrow B2). As shown in FIG. 1, the plurality of second blocks 44 are manifolds disposed so as to be separated from each other in a radial fashion around the first block 42. The fixing mechanism 46 fixes the first block 42 and the second block 44 in the up-down direction (directions of arrows A1 and A2). Here, a case where four second blocks 44 are provided as shown in FIG. 1 will be described.

The first block 42 is formed from a metallic material. The upper and lower surfaces of the first block 42 are substantially planar along the longitudinal direction. A substantially central portion of the lower surface of the first block 42 includes a recessed portion 48. The recessed portion 48 is recessed upward (in the direction of arrow A1). The recessed portion 48 comes into contact with the support plate 30 of the support base 24. The recessed portion 48 is substantially parallel to the upper surface and the lower surface of the first block 42. As shown in FIG. 2, the recessed portion 48 is larger in the longitudinal direction (directions of arrows B1 and B2) than the support plate 30 of the support base 24. The lower surface of the first block 42 includes a first sliding surface 50. The first sliding surface 50 is disposed closer to the other side in the longitudinal direction (direction of arrow B2) than the recessed portion 48. The first sliding surface 50 is slidable in contact with the upper surface of the second block 44.

The first block 42 includes a supply hole 52 and a first supply flow path 54. The supply hole 52 opens on a substantially central portion of the upper surface of the first block 42. The first supply flow path 54 communicates with the supply hole 52. The first supply flow path 54 extends in a substantially horizontal direction toward the other side in the longitudinal direction (direction of arrow B2) in the first block 42. The supply hole 52 extends downward (in the direction of arrow A2) from the upper surface of the first block 42. The supply hole 52 is connected to the first supply flow path 54. A supply nozzle 56 is connected to the supply hole 52. The supply nozzle 56 protrudes upward (in the direction of arrow A1) from the supply hole 52. The supply hole 52 and the first supply flow path 54 are connected in a substantially orthogonal manner.

The supply nozzle 56 has a cylindrical shape. A supply port 58 is provided in the center of the supply nozzle 56. The supply port 58 penetrates the supply nozzle 56 in the axial direction (directions of arrows A1 and A2). The melted resin R is supplied to the supply port 58. The outer peripheral surface of the lower end of the supply nozzle 56 has a second screw portion 60. The second screw portion 60 of the supply nozzle 56 is inserted into the supply hole 52 of the first block 42. The inner peripheral surface of the supply hole 52 has a second screw hole 62. The second screw portion 60 is screwed into the second screw hole 62. Thus, the supply nozzle 56 is fixed while protruding upward from the upper surface of the first block 42 by a predetermined length. The supply port 58 communicates with the first supply flow path 54 through the supply hole 52.

There are four first supply flow paths 54 corresponding to the number of the second blocks 44 (second supply flow paths 84). One longitudinal end of the first supply flow path 54 is connected to and communicates with the supply hole 52 at a substantially center of the first block 42. The four first supply flow paths 54 extend in a straight line from one longitudinal end toward another longitudinal end. The four first supply flow paths 54 extend radially toward the second blocks 44.

The first block 42 includes a heater H. The heater H is mounted through a groove portion of the first block 42. The groove portion has a shape corresponding to the outer shape of the heater H. The heater H is a sheathed heater. By energizing the heater H, the melted resin R flowing through the first supply flow path 54 is heated by the heater H. As a result, the melted resin R is maintained in a flowable state without being cured inside the first block 42.

Another longitudinal end (connection portion) of the first supply flow path 54 includes a first connecting path 64. The first connecting path 64 is bent at a substantially right angle from the first supply flow path 54 and extends downward (in the direction of arrow A2). The first connecting path 64 opens on the lower surface of the first block 42. The first connecting path 64 includes a first widening portion 66 recessed outward from the inner wall of the first supply flow path 54. The first widening portion 66 widens upward (in the direction of arrow A1) from the first connecting path 64. The first widening portion 66 widens from the first connecting path 64 toward one side in the longitudinal direction and the other side in the longitudinal direction. A first flow path forming member 68 is attached to the first widening portion 66. The first flow path forming member 68 forms a part of the flow path.

A first flow path 70 is provided inside the first flow path forming member 68. The first flow path 70 has an L-shaped cross-sectional shape. By mounting the first flow path forming member 68 to the first widening portion 66, the first flow path 70 and the first supply flow path 54 communicate with each other. That is, the first flow path 70 and the first connecting path 64 are connected so as to be continuous. The other longitudinal end of the first block 42 has a first adjusting screw hole 74. The first adjusting screw hole 74 penetrates the first block 42 in the longitudinal direction. A first adjusting screw 72 is screwed into the first adjusting screw hole 74. The first adjusting screw hole 74 communicates with the first connecting path 64. One longitudinal end of the first adjusting screw 72 can contact another longitudinal end of the first flow path forming member 68.

By screwing the first adjusting screw 72, the first adjusting screw 72 can be moved back and forth in the longitudinal direction of the first block 42 (in the directions of arrows B1 and B2). By moving the first adjusting screw 72, the first flow path forming member 68 can be moved in the longitudinal direction. According to the back and forth movement of the first adjusting screw 72, the first flow path forming member 68 can be fixed by adjusting the position thereof along the longitudinal direction in the first widening portion 66 (first connecting path 64).

The first flow path forming member 68 and the first block 42 may be made of the same material. The first flow path forming member 68 and the first block 42 may be made of different materials. When the first flow path forming member 68 and the first block 42 are made of different materials, the shape of the first connecting path 64 can be easily and freely formed.

The second block 44 is formed from a metallic material. In the longitudinal direction of the hot runner device 10, one longitudinal end (second end portion) of the second block 44 and the other longitudinal end (first end portion) of the first block 42 overlap each other. In other words, the second block 44 is offset from the first block 42 in the longitudinal direction. The upper surface and a lower surface 44a of the second block 44 are substantially planar along the longitudinal direction of the second block 44. The other longitudinal end of the second block 44 has a third screw hole 76. The nozzle unit 20 to be described later is connected to the third screw hole 76. The nozzle unit 20 is orthogonal to the longitudinal direction of the second block 44.

The upper surface of the second block 44 has a second sliding surface 78. The second sliding surface 78 is disposed on one side in the longitudinal direction of the second block 44. The second sliding surface 78 is slidable in contact with the first sliding surface 50 of the first block 42. The second sliding surface 78 comes into surface contact with the first sliding surface 50 of the first block 42. A heater H is mounted on the upper surface of the second block 44 through a groove portion. The heater H is a sheathed heater similarly to the heater H mounted on the first block 42. By energizing the heater H, the melted resin R flowing through the second supply flow path 84 is heated by the heater H. As a result, the melted resin R is maintained in a flowable state without being cured inside the second block 44.

The lower surface 44a of the second block 44 is a surface facing the fixed mold 12. The lower surface 44a of the second block 44 includes first and second insertion holes 80 and 82. The first and second insertion holes 80 and 82 are disposed between one longitudinal end and the other longitudinal end of the second block 44. The first positioning pin 38 fitted to the fixed mold 12 is inserted into the first insertion hole (first hole portion) 80. The second positioning pin 40 fitted to the fixed mold 12 is inserted into the second insertion hole (second hole portion) 82. As shown in FIGS. 2 to 5, the first insertion hole 80 is recessed upward (in the direction of arrow A1) from the lower surface 44a of the second block 44. The first insertion hole 80 is disposed on one side in the longitudinal direction (the direction of arrow B1) in the second block 44.

The second insertion hole 82 is recessed upward (in the direction of arrow A1) from the lower surface 44a of the second block 44. The depth of the second insertion hole 82 and the depth of the first insertion hole 80 are the same. The second insertion hole 82 is disposed on the other side in the longitudinal direction (the direction of arrow B2) in the second block 44. The first and second insertion holes 80 and 82 are separated from each other by a predetermined distance in the longitudinal direction of the second block 44. The first and second insertion holes 80 and 82 respectively face the first and second fitting holes 34 and 36 in the fixed mold 12.

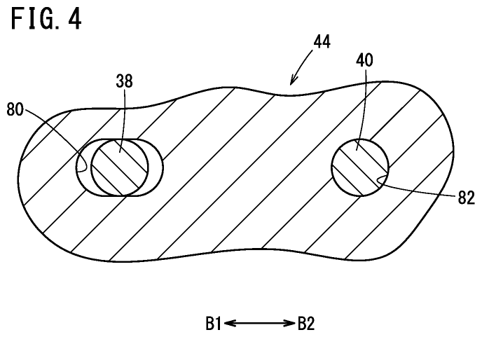

As shown in FIG. 4, the first insertion hole 80 is a long hole that is elongated in the longitudinal direction of the second block 44 (in the directions of arrows B1 and B2). The second insertion hole 82 has a circular cross-sectional shape. The cross-sectional shape of the second insertion hole 82 is the same as the cross-sectional shape of the second positioning pin 40. In other words, the size of the first insertion hole 80 along the longitudinal direction is larger than the size of the second insertion hole 82 along the longitudinal direction.

As shown in FIGS. 2 to 5, the upper half of the first positioning pin 38 is inserted into the first insertion hole 80. The upper half of the second positioning pin 40 is inserted into the second insertion hole 82. A washer member 104 is inserted through the first positioning pin (holding member) 38. The washer member 104 is disposed between the lower surface 44a of the second block 44 and the upper surface of the fixed mold 12. The upper end of the first positioning pin 38 contacts and supports the upper surface of the first insertion hole 80. The washer member 104 has an annular shape. The washer member 104 is held between the lower surface 44a of the second block 44 and the upper surface of the fixed mold 12.

The second supply flow path 84 is provided inside the second block 44. The second supply flow path 84 extends in the substantially horizontal direction from one longitudinal end to another longitudinal end. One longitudinal end of the second supply flow path 84 is provided with a second connecting path 86. The second connecting path 86 is bent at a substantially right angle from the second supply flow path 84 and extends upward (in the direction of arrow A1). The second connecting path 86 opens on the upper surface of the second block 44.

The second connecting path 86 faces the first connecting path 64 of the first block 42 in the up-down direction (directions of arrows A1 and A2). The second connecting path 86 communicates with the first connecting path 64. A second widening portion 88 is provided inside the second connecting path 86. The second widening portion 88 widens downward (in the direction of arrow A2) from the second connecting path 86. The second widening portion 88 widens from the second connecting path 86 toward one side in the longitudinal direction (the direction of arrow B1) and the other side in the longitudinal direction (the direction of arrow B2). A second flow path forming member 90 is attached to the second widening portion 88. The second flow path forming member 90 forms a part of the flow path.

A second flow path 92 is provided inside the second flow path forming member 90. The second flow path 92 has an L-shaped cross-sectional shape. By mounting the second flow path forming member 90 to the second widening portion 88, the second flow path 92 and the second supply flow path 84 communicate with each other. That is, the second flow path 92 and the second connecting path 86 are connected so as to be continuous.

One longitudinal end of the second block 44 has a second adjusting screw hole 96. The second adjusting screw hole 96 penetrates the second block 44 in the longitudinal direction. A second adjusting screw 94 is screwed into the second adjusting screw hole 96. The second adjusting screw hole 96 communicates with the second connecting path 86. Another longitudinal end of the second adjusting screw 94 can contact one longitudinal end of the second flow path forming member 90.

By screwing the second adjusting screw 94, the second adjusting screw 94 can be moved back and forth in the longitudinal direction of the second block 44 (in the directions of arrows B1 and B2). According to the back and forth movement of the second adjusting screw 94, the second flow path forming member 90 can be fixed by adjusting the position thereof along the longitudinal direction in the second widening portion 88 (second connecting path 86).

The second flow path forming member 90 and the second block 44 may be made of the same material. The second flow path forming member 90 and the second block 44 may be made of different materials. When the second flow path forming member 90 and the second block 44 are made of different materials, the shape of the second connecting path 86 can be easily formed.

Another longitudinal end of the second supply flow path 84 includes a third connecting path 98. The third connecting path 98 is bent at a substantially right angle from the second supply flow path 84 and extends downward (in the direction of arrow A2). The third connecting path 98 opens on the lower surface 44a of the second block 44. The third connecting path 98 communicates with the third screw hole 76. The third connecting path 98 communicates with the inside of a casing 116 of the nozzle unit 20 connected to the third screw hole 76.

That is, the second supply flow path 84 has a crank shape such that one longitudinal end of the second supply flow path 84 is bent upward (in the direction of arrow A1) by the second connecting path 86, and the other longitudinal end of the second supply flow path 84 is bent downward (in the direction of arrow A2) by the third connecting path 98.

As shown in FIGS. 1 to 3, the fixing mechanism 46 includes a fixing base 100, a nut member (fixing member, holding member) 102, and the washer member 104. The fixing base 100 is disposed above the first block 42. The nut member 102 is disposed in the lower portion of the fixing base 100. The washer member 104 is disposed to be aligned with the nut member 102 in the up-down direction. The washer member 104 is disposed between the second block 44 and the fixed mold 12. The fixing mechanism 46 faces the vicinity of the other longitudinal end of the first block 42. The fixing mechanism 46 faces the vicinity of one longitudinal end of the second block 44.

The fixing base 100 includes a bolt hole 106. The bolt hole 106 penetrates the fixing base 100 in the up-down direction (directions of arrows A1 and A2). A fixing bolt 108 is inserted through the bolt hole 106. The lower surface of the fixing base 100 includes an accommodation hole 109. The accommodation hole 109 is recessed upward from the lower surface of the fixing base 100. The accommodation hole 109 communicates with the lower end of the bolt hole 106. A part of the nut member 102 is accommodated in the accommodation hole 109. The nut member 102 is disposed between the upper surface of the first block 42 and the fixing base 100.

The bolt hole 106 of the fixing base 100 is disposed above the first connecting path 64 in the first block 42 (in the direction of arrow A1). The bolt hole 106 and the first connecting path 64 are arranged in a substantially straight line. The bolt hole 106 is disposed above the second connecting path 86 in the second block 44 (in the direction of arrow A1). The bolt hole 106 and the second connecting path 86 are arranged in a substantially straight line. The fixing bolt 108 is screwed into the nut member 102. A part of the nut member 102 is accommodated in the accommodation hole 109. The nut member 102 protrudes downward from the lower surface of the fixing base 100. The nut member 102 comes into contact with the upper surface of the first block 42. Thus, the fixing base 100 is fixed to the upper surface of the first block 42 via the nut member 102.

In the hot runner block 18, as shown in FIG. 3, when the first sliding surface 50 of the first block 42 and the second sliding surface 78 of the second block 44 come into contact with each other, the first and second connecting paths 64 and 86 face the first positioning pin 38, the washer member 104, the nut member 102, and the fixing bolt 108.

The first block 42 and the second block 44 are held and fixed in the up-down direction (directions of arrows A1 and A2).

The nozzle unit 20 includes the gate valve 110 and a cylinder mechanism 114. The gate valve 110 has a tubular shape and is accommodated in the fixed mold 12. The cylinder mechanism 114 moves a stem 112 of the gate valve 110 up and down in the up-down direction (directions of arrows A1 and A2).

As shown in FIGS. 1 to 3, the gate valve 110 is accommodated in the installation hole 32 of the fixed mold 12. The gate valve 110 extends in the up-down direction (directions of arrows A1 and A2) along the installation hole 32. The gate valve 110 is disposed coaxially with the installation hole 32. The gate valve 110 includes the casing (nozzle) 116 and the stem 112. The casing 116 has a cylindrical shape. The stem 112 is accommodated inside the casing 116 so as to be movable up and down. The outer peripheral surface of the upper end of the casing 116 has a third screw portion 118. The third screw portion 118 is inserted into and screwed into the third screw hole 76 of the second block 44. When the third screw portion 118 is screwed into the third screw hole 76, the gate valve 110 is connected to the other longitudinal end of the second block 44. The gate valve 110 is orthogonal to the second block 44.

Thus, the inside of the casing 116 communicates with the second supply flow path 84, the first supply flow path 54, and the supply hole 52 through the third connecting path 98. The first supply flow path 54, the second supply flow path 84, the third connecting path 98 and the supply hole 52 function as flow paths through which the melted resin R can flow.

The lower end of the casing 116 has a fourth screw portion 120. The fourth screw portion 120 is formed on the outer peripheral surface of the lower end of the casing 116. An adapter 122 is screwed and connected to the lower end of the casing 116 via the fourth screw portion 120. The adapter 122 is inserted into the lower end of the installation hole 32. The lower end of the gate valve 110 is positioned and fixed in a predetermined position of the fixed mold 12 via the adapter 122. The gate valve 110 is held coaxially with the installation hole 32. The lower end of the adapter 122 is substantially flush with the lower end of the fixed mold 12.

The stem 112 has a substantially constant diameter and is elongated in the axial direction (directions of arrows A1 and A2). The stem 112 is a shaft body having a substantially constant diameter. The upper end of the stem 112 protrudes upward (in the direction of arrow A1) from the upper end of the casing 116. The upper end of the stem 112 is inserted through a hole portion of the second block 44. The upper end of the stem 112 is exposed upward from the upper surface of second block 44. The lower end of the stem 112 protrudes downward (in the direction of arrow A2) from the lower end of the casing 116. The lower end of the stem 112 can be inserted into a gate hole (gate) 124 of the adapter 122 (see FIG. 2).

The cylinder mechanism 114 includes a cylinder body 126, a piston 128, and a rod 130. The piston 128 is accommodated inside the cylinder body 126 so as to be advanceable and retractable. The rod 130 is connected to the lower end of the piston 128. The rod 130 protrudes downward (in the direction of arrow A2) from the cylinder body 126. The lower end of the cylinder body 126 is fixed to a base member 132. The lower end of the rod 130 is connected to the upper end of the stem 112.

A pressurized fluid is supplied into the cylinder body 126 through a first port 134. As shown in FIGS. 2 and 3, in accordance with the supply of the pressurized fluid into the cylinder body 126, the piston 128 and the rod 130 are pushed by the pressurized fluid and are lowered. When the piston 128 and the rod 130 are lowered, the stem 112 is moved downward (in the direction of arrow A2). The moving direction of the stem 112 corresponds to the “first direction” in the present invention. The lower end of the stem 112 is inserted into the gate hole 124 of the adapter 122. As a result, the gate hole 124 is closed by the lower end of the stem 112, and the communication between the inside of the casing 116 and the cavity 22 through the gate hole 124 is blocked.

Next, the operation and effects of the hot runner device 10 will be described.

First, as shown in FIGS. 2 and 3, the gate hole 124 is closed by the stem 112 of the nozzle unit 20. The melted resin R obtained by heating and melting the resin material is supplied to the supply port 58 of the supply nozzle 56. The melted resin R flows from the supply port 58 through the supply hole 52 to the first supply flow path 54. The melted resin R flows in the substantially horizontal direction toward the other side in the longitudinal direction of the first supply flow path 54. The melted resin R flows radially along the plurality of first supply flow paths 54. The melted resin R flows into the first flow path 70 of the first flow path forming member 68 in the first connecting path 64. The melted resin R flows from the first flow path 70 to the second flow path 92 of the second flow path forming member 90 in the second connecting path 86. The melted resin R flows through the second flow path 92 to the second supply flow path 84 of the second block 44.

The melted resin R flows in the substantially horizontal direction along the second supply flow path 84. The melted resin R flows to the other longitudinal end of the second supply flow path 84 and then flows to the third connecting path 98. The melted resin R flows into the casing 116 of the nozzle unit 20 through the third connecting path 98. As a result, the insides of the casing 116 and the first and second supply flow paths 54 and 84 are filled with the melted resin R.

At this time, the first and second blocks 42 and 44 are heated by the heaters H, and with heating by the heaters H, thermal expansion occurs in the first and second blocks 42 and 44. The first sliding surface 50 of the first block 42 and the second sliding surface 78 of the second block 44 are movable relative to each other in the longitudinal direction (directions of arrows B1 and B2). Therefore, although thermal expansion stress due to the thermal expansion is applied to the first and second blocks 42 and 44, the first block 42 and the second block 44 relatively move in the longitudinal direction at this time, thereby absorbing the thermal expansion of the first block 42 and the second block 44. Thus, deformation of the first block 42 and the second block 44 caused by the thermal expansion is suppressed.

At a connecting part between the first block 42 and the second block 44, the first connecting path 64 and the second connecting path 86 extend in the up-down direction (directions of arrows A1 and A2), and are connected to each other. When the melted resin R flows through the first connecting path 64 and the second connecting path 86, the pressure of the melted resin R supplied from an injection molding machine (not shown) is applied to the connecting part in the up-down direction. That is, the pressure of the melted resin R is applied in such a manner that the first block 42 and the second block 44 are separated from each other in the up-down direction.

The first block 42 and the second block 44 are held and fixed from above and below by the fixing mechanism 46 including the nut member 102 and the washer member 104. Therefore, the first connecting path 64 and the second connecting path 86 are connected in the axial direction so as to be sandwiched from above and below. This prevents the first block 42 and the second block 44 from being separated from each other in the up-down direction due to the pressure of the melted resin R. As a result, it is possible to prevent the first block 42 and the second block 44 from being separated from each other in the up-down direction, thereby preventing the melted resin R from leaking out from between the first block 42 and the second block 44.

The second block 44 is engaged with the fixed mold 12 by the first and second positioning pins 38 and 40. Therefore, when the second block 44 is moved in the longitudinal direction by thermal expansion, the amount of deformation (amount of movement) of the second block 44 along the longitudinal direction falls within a predetermined range. The second positioning pin 40 close to the nozzle unit 20 is used as a deformation reference for the second block 44. One side of the second block 44 in the longitudinal direction, which is the side opposite to the nozzle unit 20, is close to the first positioning pin 38. One side of the second block 44 in the longitudinal direction is engaged with the long first insertion hole 80 through the first positioning pin 38. Therefore, one side of the second block 44 in the longitudinal direction is allowed to move in the longitudinal direction (directions of arrows B1 and B2).

When the second block 44 moves along the longitudinal direction due to deformation caused by thermal expansion, the movement of the other side of the second block 44 in the longitudinal direction is restricted by the second positioning pin 40. On the other hand, when the second block 44 moves along the longitudinal direction due to deformation caused by thermal expansion, one side of the second block 44 in the longitudinal direction is allowed to move through the first positioning pin 38. Therefore, the nozzle unit 20 connected to the other side of the second block 44 in the longitudinal side is prevented from being pressed in the longitudinal direction due to deformation caused by thermal expansion. This prevents the nozzle unit 20 from being shifted from a predetermined position in the hot runner device 10. As a result, when the hot runner block 18 including the second block 44 is deformed due to thermal expansion, the upper end of the nozzle unit 20 is prevented from being inclined with respect to the lower end of the nozzle unit 20 held by the fixed mold 12.

As shown in FIG. 5, the pressurized fluid supplied to the first port 134 of the cylinder mechanism 114 is supplied to a second port 136. In the cylinder mechanism 114, the pressurized fluid is supplied from the second port 136 to the inside of the cylinder body 126. The piston 128 and the rod 130 are pushed and moved upward (in the direction of arrow A1) by the pressurized fluid. As the rod 130 moves, the stem 112 moves upward (in the direction of arrow A1) within the casing 116. As a result, the lower end of the stem 112 is separated from the gate hole 124 of the adapter 122 to open the gate hole 124. The melted resin R flows from the inside of the casing 116 through the gate hole 124 to the inside of the cavity 22.

After the cavity 22 is filled with the melted resin R, the melted resin R is cooled in the cavity 22 for a predetermined time. Thus, the melted resin R is solidified in the cavity 22, and a resin molded article having a shape corresponding to the shape of the cavity 22 can be obtained.

Finally, a drive device (not shown) is driven to lower the movable mold 14. The movable mold 14 is separated from the fixed mold 12 by a predetermined distance to open the mold. The resin molded article is released from the fixed mold 12 or the movable mold 14 which are separated from each other in the up-down direction. As a result, the resin molded article is taken out from the cavity 22.

As described above, in the present embodiment, the hot runner device 10 includes the fixed mold 12 having the cavity 22, and the hot runner block 18 fixed to the fixed mold 12. The supply nozzle 56 to which the melted resin R is supplied is connected to the hot runner block 18. The hot runner block 18 includes the first block 42, the second block 44, and the fixing mechanism 46. The first supply flow path 54 is provided inside the first block 42. The first supply flow path 54 communicates with the supply port 58 of the supply nozzle 56. The melted resin R flows through the first supply flow path 54. The second block 44 is connected to the first block 42. The second supply flow path 84 is provided inside the second block 44. The nozzle unit 20 is connected to the second supply flow path 84. The melted resin R flows through the second supply flow path 84. The other longitudinal end of the first block 42 and one longitudinal end of the second block 44 are slidably connected to each other along the longitudinal direction (directions of arrows B1 and B2). The fixing mechanism 46 fixes the connecting part between the first block 42 and the second block 44, in the up-down direction (directions of arrows A1 and A2).

The second block 44 includes the lower surface 44a facing the fixed mold 12. The lower surface 44a of the second block 44 has the first and second insertion holes 80 and 82. The first and second positioning pins 38 and 40 are inserted into the first and second insertion holes 80 and 82, respectively. The first insertion hole 80 is disposed close to the supply nozzle 56. The second insertion hole 82 is disposed close to the nozzle unit 20. The first insertion hole 80 is longer in the longitudinal direction than the second insertion hole 82.

When the hot runner block 18 is thermally expanded, thermal expansion stress generated by the thermal expansion is applied to the first and second blocks 42 and 44. The first block 42 and the second block 44 move relative to each other in the longitudinal direction (directions of arrows B1 and B2). Therefore, since the first block 42 and the second block 44 move relative to each other, the thermal expansion stress generated during thermal expansion can be appropriately absorbed. As a result, deformation of the first and second blocks 42 and 44 due to the thermal expansion can be suppressed.

When the second block 44 is deformed by thermal expansion, the amount of deformation at the other longitudinal end of the second block 44 toward the nozzle unit 20 can be suppressed by using the second positioning pin 40 as a deformation reference. On the other hand, when the second block 44 is deformed by thermal expansion, the deformation at one longitudinal end of the second block 44 toward the supply nozzle 56 is allowed. With this configuration, when the second block 44 is deformed by the thermal expansion stress, the inclination of the nozzle unit 20 can be suitably suppressed, and the thermal expansion stress applied to the second block 44 can be suitably absorbed at one longitudinal end of the second block 44.

As a result, in the hot runner device 10, the occurrence of inclination of the nozzle unit 20 due to thermal expansion can be suppressed, and the stem 112 of the nozzle unit 20 can be reliably moved in the up-down direction. Therefore, even when the second block 44 is deformed by the thermal expansion stress, the state of supply of the melted resin R to the cavity 22 can be reliably switched by the nozzle unit 20.

The first and second positioning pins 38 and 40 are attached to the lower surface 44a of the second block 44. The first positioning pin 38 is disposed at the connecting part between the first block 42 and the second block 44. The first positioning pin 38 is disposed at a position facing the first and second connecting paths 64 and 86 in the longitudinal direction of the second block 44. The first positioning pin 38 is inserted into the first insertion hole 80.

The second positioning pin 40 is disposed between the first and second connecting paths 64 and 86 and the nozzle unit 20 in the longitudinal direction of the second block 44. The second positioning pin 40 is inserted into the second insertion hole 82.

When the melted resin R is supplied to the first and second connecting paths 64 and 86, the pressure of the melted resin R is applied to the first and second blocks 42 and 44 in the up-down direction. At this time, by supporting the second block 44 by the first positioning pin 38 disposed at a position facing the first and second connecting paths 64 and 86, the deflection (deformation) of the first and second blocks 42 and 44 toward the fixed mold 12 is suppressed. Therefore, it is possible to reliably prevent the melted resin R from leaking out from between the first block 42 and the second block 44.

The second positioning pin 40 is fitted into the second insertion hole 82 of the second block 44. When the second block 44 is deformed by the thermal expansion stress, the other longitudinal end of the second block 44 close to the nozzle unit 20 can be used as the deformation reference for the second block 44. The upper end of the nozzle unit 20 is connected to the other longitudinal end of the second block 44. Thus, when the second block 44 is deformed by thermal expansion, the movement of the upper end of the nozzle unit 20 in the longitudinal direction can be suppressed. As a result, when the second block 44 is deformed by the thermal expansion stress, the inclination of the nozzle unit 20 can be suppressed.

The fixing mechanism 46 holds the connecting part between the first block 42 and the second block 44, in the up-down direction. The fixing mechanism 46 includes the first positioning pin 38 and the nut member 102. The first positioning pin 38 is attached to the lower surface 44a of the second block 44. The first positioning pin 38 comes into contact with the upper surface of the first insertion hole 80. The nut member 102 comes into contact with the upper surface of the first block 42. The hot runner block 18 including the second block 44 can be positioned relative to the fixed mold 12 in the longitudinal direction by the first positioning pin 38. The connecting part between the first block 42 and the second block 44 can be firmly fixed in the up-down direction by the first positioning pin 38 and the nut member 102.

When the melted resin R is supplied to the first and second connecting paths 64 and 86, the pressure of the melted resin R is applied to the connecting part between the first and second blocks 42 and 44 in the up-down direction. As described above, the connecting part between the first block 42 and the second block 44 is held by the first positioning pin 38. As a result, by using the first positioning pin 38 for positioning the second block 44 in the longitudinal direction, it is possible to reliably prevent the melted resin R from leaking out from between the first block 42 and the second block 44. Therefore, the number of parts of the hot runner device 10 can be reduced as compared with the case where another fixing member for fixing the connecting part between the first block 42 and the second block 44 is provided instead of the first positioning pin 38. As a result, the manufacturing cost of the hot runner device 10 can be reduced.

The first insertion hole 80 is a long hole that is elongated in the longitudinal direction of the second block 44. The first positioning pin 38 is inserted into the first insertion hole 80. When pressure is applied to the second block 44 due to the thermal expansion stress, one longitudinal end of the second block 44 is movable in the longitudinal direction (directions of arrows B1 and B2) through the first insertion hole 80. Therefore, the thermal expansion stress generated in the second block 44 can be appropriately absorbed. By preventing the deformation by absorbing the thermal expansion stress generated in the second block 44, the influence of the thermal expansion stress on the nozzle unit 20 can be suppressed. Thus, the inclination of the nozzle unit 20 can be more reliably suppressed.

The supply nozzle 56 is screwed and fixed to the supply hole 52 of the first block 42. The upper end of the casing 116 in the nozzle unit 20 is screwed and fixed to the third screw hole 76 opened at the other longitudinal end of the second block 44. Therefore, since the supply nozzle 56 and the first block 42 can be firmly connected by screw fastening, the melted resin R is reliably prevented from leaking out through the space between the supply nozzle 56 and the first block 42. Further, since the nozzle unit 20 and the second block 44 can be firmly connected by screw fastening, the melted resin R is reliably prevented from leaking out through the space between the nozzle unit 20 and the second block 44.

The above embodiment is summarized as follows.

The above embodiment relates to a hot runner device (10) comprising: a fixed mold (12) including a cavity (22); a runner block (18) fixed to the fixed mold; a nozzle (20) having a tubular shape and fixed to the fixed mold and the runner block in a manner that a tip of the nozzle faces the cavity; and a stem (112) movable in the nozzle in an axial direction of the nozzle and configured to open and close a gate (124) opened at the tip of the nozzle, the hot runner device filling the cavity with injected melted resin (R) from the gate through the runner block, wherein the runner block includes: a first block (42) connected to a supply port (58) to which the melted resin is supplied, and including, on an inside thereof, a first supply flow path (54) which communicates with the supply port and through which the melted resin flows; a second block (44) connected to the first block and to the nozzle, and including, on an inside thereof, a second supply flow path (84) through which the melted resin flows; a connection portion configured to connect a first end portion of the first block and a second end portion of the second block in a manner that the first end portion and the second end portion are slidable relative to each other along a second direction substantially orthogonal to a first direction that is a direction in which the stem moves, the connection portion being configured to allow the first supply flow path and the second supply flow path to communicate with each other; and a fixing mechanism (46) provided at a position where the fixing mechanism overlaps the connection portion in the second direction, and configured to fix the connection portion, and wherein the second block includes, on a surface (44a) facing the fixed mold, a plurality of hole portions (80, 82) each engaged with a positioning member (38, 40), and among the plurality of hole portions, a first hole portion (80) which is farthest from the nozzle in the second direction is larger than a second hole portion (82) which is closest to the nozzle in the second direction.

The positioning member is provided in plurality on the surface facing the fixed mold, and includes a first positioning pin (38) provided at a position facing the connection portion in the second direction; and a second positioning pin (40) provided between the connection portion and the nozzle in the second direction, and the first positioning pin is engaged with the first hole portion, and the second positioning pin is engaged with the second hole portion.

The second positioning pin is fitted into the second hole portion.

The fixing mechanism includes a set of holding members configured to hold the connection portion, and one of the holding members includes a first positioning pin provided on a surface of the connection portion that faces the fixed mold, and another of the holding members is a fixing member (102) disposed on a surface of the first block on an opposite side to a surface thereof facing the second block.

The first hole portion is a long hole elongated in a longitudinal direction of the second block.

The supply port is screwed and fixed to the first block, and the nozzle is screwed and fixed to the second block.

The present invention is not limited to the above-described embodiment, and various configurations can be adopted therein without departing from the gist of the present invention.

What is claimed is:

1. A hot runner device comprising:
a fixed mold including a cavity;
a runner block fixed to the fixed mold;
a nozzle having a tubular shape and fixed to the fixed mold and the runner block in a manner that a tip of the nozzle faces the cavity; and
a stem movable in the nozzle in an axial direction of the nozzle and configured to open and close a gate opened at the tip of the nozzle,
the hot runner device filling the cavity with injected melted resin from the gate through the runner block, wherein
the runner block includes:
a first block connected to a supply port to which the melted resin is supplied, and including, on an inside thereof, a first supply flow path which communicates with the supply port and through which the melted resin flows;
a second block connected to the first block and to the nozzle, and including, on an inside thereof, a second supply flow path through which the melted resin flows;
a connection portion configured to connect a first end portion of the first block and a second end portion of the second block in a manner that the first end portion and the second end portion are slidable relative to each other along a second direction substantially orthogonal to a first direction that is a direction in which the stem moves, the connection portion being configured to allow the first supply flow path and the second supply flow path to communicate with each other; and
a fixing mechanism provided at a position where the fixing mechanism overlaps the connection portion in the second direction, and configured to fix the connection portion, and wherein
the second block includes, on a surface facing the fixed mold, a plurality of hole portions each engaged with a positioning member, and among the plurality of hole portions, a first hole portion which is farthest from the nozzle in the second direction is larger than a second hole portion which is closest to the nozzle in the second direction.

2. The hot runner device according to claim 1, wherein
the positioning member includes:
a first positioning pin provided at a position where the first positioning pin overlaps the connection portion in the second direction; and
a second positioning pin provided between the connection portion and the nozzle in the second direction, and
the first positioning pin is engaged with the first hole portion, and the second positioning pin is engaged with the second hole portion.

3. The hot runner device according to claim 2, wherein
the second positioning pin is fitted into the second hole portion.

4. The hot runner device according to claim 1, wherein
the fixing mechanism includes a set of holding members configured to hold the connection portion, and
one of the holding members includes a first positioning pin provided on a surface of the connection portion that faces the fixed mold, and another of the holding members is a fixing member disposed on a surface of the first block on an opposite side to a surface thereof facing the second block.

5. The hot runner device according to claim 1, wherein
the first hole portion is a long hole elongated in a longitudinal direction of the second block.

6. The hot runner device according to claim 1, wherein
the supply port is screwed and fixed to the first block, and the nozzle is screwed and fixed to the second block.
